(19) United States
(12) Patent Application Publication
(10) Pub. No.: US 2002/0076229 A1
(43) Pub. Date: Jun. 20, 2002

(54) Method and device for generating and adjusting temperature values in a fixing roller of a toner image fixing unit

(76) Inventor: Franz Allmendinger, Aichwald (DE)

Correspondence Address: Lawrence P. Kessler, Patent Department, NexPress Solutions LLC, 1447 St. Paul Street, Rochester, NY, 14653-7103, US

(21) Appl. No.: 09/850,451

(22) Filed: May 7, 2001

(30) Foreign Application Priority Data
May 18, 2000 (DE) 100 24 134.4

(51) Int. Cl. G03G 15/20

(52) U.S. Cl. 399/69

(57) ABSTRACT

The invention pertains to a method and device for generating and adjusting temperature values (T1, T2, T3) in a fixing roller (FR) of a fixing unit, which is mounted in a copy machine, can be switched over to various operational states (W, A, and F) and can be used for fixing of toner images transferred on imaging materials (P); whereby the fixing roller together with a pressing roller (PR), which can be positioned axially parallel to its outer surface (FS), form a fixing opening (N) for feeding of imaging materials carrying toner images; the fixing roller can be heated by means of a heating unit (H1) connected to a control/adjustment unit (CU), can be switched over to generate and adjust predetermined temperature values (T1, T2, T3), and its heating level (Ph) can be regulated; the temperature values (T1, T2, T3) at the outer surface (FS) of the fixing roller can be measured by means of at least one temperature sensor (ST); and the outer surface of the fixing roller can be cooled out by means of blowing airflow (AJ, AJ1-3) supplied by a controllable cooling unit (CO). It pertains to achieving a method and a device that guarantee the fast, precise, and simple operation of a fixing unit, and particularly the fast and precise generation and adjustment of predetermined temperature values on a fixing roller in different operational states for accelerating and improving the fixing process in an automated environment; the generation and adjustment of predetermined temperature values (T1, T2, T3) on the outer surface (FS) of the fixing roller (FR) is performed essentially by means of a controllable and adjustable blowing airflow (AJ, AJ1-3) of the cooling unit (CO); furthermore, the control and adjustment of the blowing airflow (AJ, AJ1-3) is performed depending on the obtained core temperature (Tc) of the fixing roller (FR); and the cooling unit (CO) has at least one blowing air unit (AT, AT1-3), which is essentially built in the form of a pipe, is connected to a compressed air source (BL, AS), and is mounted in a stationary manner axially parallel to the fixing roller (FR) and radially at a distance from its outer surface (FS), whereby a focused and concentrated blowing airflow (AJ, AH1-3) for the creation of cooling strip (CA, CA1-3) on the outer surface of the fixing roller can be generated, and whose blowing air level (Pc) can be controlled and adjusted by means of a control/adjustment unit acting upon the compressed air source (BL, AS).

### DESCRIPTION

The invention pertains to a method and device for generating and adjusting temperature values in a fixing roller of a fixing unit, which is mounted in a copy machine, can be switched over to various operational states, and can be used for fixing of toner images transferred on imaging materials.

There are some known fixing units with a device and a method of the above mentioned kind, which are used in copy machines, whereby the rotating fixing roller along with a pressing roller that can be mounted to its outer surface parallel with the axis form an opening, through which the imaging materials that carry the toner image could pass; the fixing roller can be heated by means of a heating agent connected to a controvadjustment unit whose heating level can be set up at different levels for generating and adjusting the preset temperature values; the temperature values at the outer surface of the fixing roller can be registered by means of at least one temperature sensor; and the outer surface of the fixing roller can be cooled out by an airflow blowing unit fed from a controllable cooling unit.

A U.S. Pat. No. 5,787,321 patent reveals a device for generating and adjusting an operational or fixer temperature value at the outer circumference of heated and revolving fixing rollers of a fixing unit, whereby the fixing rollers are arranged as a pair of rollers parallel with the axis and this pair consists of a heating roller and a pressing roller. A number of temperature sensors along with the airflow blowing units assigned to them are arranged axially along both fixing rollers and are positioned axially at a distance from one another and in front of the fixing rollers in the direction of the flow, whereby the axial cross-section width of an airflow blowing unit, or to be more precise-its aired area, corresponds to the smallest width of the sheet carrying the toner image. In order to prevent an overheating of the top surfaces of the uncovered fixing rollers, which are not protected by the sheet running through the fixing opening, airflow blowing units are turned on and pointed towards it or them by means of a control unit, whereby the airflow blowing units are arranged in the so called sheet-free area of the fixing rollers. The generation and adjustment of temperature values, and especially the temperature of the fixer, as well as the switching over to the different operational states is done essentially by means of a heating level control/adjustment unit.

A disadvantage of the presented form of implementation is that a focused, homogeneous, and intensive cooling over the whole axial length of the fixing rollers by using the described airflow blowing units with a large opening for the flow can be only inadequately achieved. Furthermore, due to the arrangement of the temperature sensors in the airflow, it is difficult to achieve an exact measurement of the temperature values at the outer surface of the fixing rollers. Also, due to its sluggishness, the used method of control/adjustment of the heating level is disadvantageous from the point of view of achieving fast generation, adjustment, and change of the temperature values, and particularly of the fixer temperature, as well as faster switching over to different operational states.

A DE-25 07 559-A patent reveals a device and a method for generating an operational or fixer temperature value at the outer circumference of heated and revolving fixing rollers of a fixing unit, whereby the heating roller and the pressing roller together form a pair of fixing rollers. A sucking unit for cooling the surfaces of both rollers is mounted at the top of the pressing roller. The sucking unit exhibits an airflow directing channel, which is aligned with the conveyor belt for transportation of the sheet and respectively axially aligned with the pressing roller. On the one hand, the airflow directing channel is connected through a single switching valve with a low-pressure generating unit, and, on the other hand, it has on both sides of the air channel a number of narrow air channels/air-pipes, which are parallel to each other, extend themselves axially up to both ends of the pressure roller, and lead into the air channel. The air pipes, which are positioned radially with respect to the surface of the pressing roller and at a distance from one another, are arranged in the direction of the pressing roller and along the outer circumference one behind the other at an angular interval of about 5-10 degrees. Each one of the air pipes has in its pipe wall a number of air nozzles, which are arranged one next to the other along the axial extension of the pipes and are lined up in such a way on the pressing roller that-in order to prevent overheating only the end areas, respectively the ends of the roller pairs that jut over the sheet width, are cooled out. The generation and adjustment of the temperature values, and particularly the fixer temperature, as well as the switching over to the different operational states are performed essentially by means of a heating level control/adjustment unit.

A disadvantage of the presented form of implementation is that due to the use of the described sucking unit, which is mounted in the area of the pressing roller and whose cooling action is limited essentially to the axial end areas of the rollers, a focused, homogeneous, and intensive cooling over the whole axial length of the fixing rollers is not possible. Further disadvantage is that the air pipes cannot be separately controlled in order to vary the cooling action. Furthermore, due to its sluggishness, the used method of control/adjustment of the heating level is disadvantageous from the point of view of achieving fast generation, adjustment, and change of the temperature values, and particularly of the fixer temperature, as well as faster switching over to different operational states.

Therefore, the fundamental objective of the present invention is to create a method and a device of the kind mentioned at the beginning that does not have the above mentioned disadvantages and, what is more, guarantees the faster, more precise and simpler functioning of the fixing unit, and particularly a faster and more precise generation and adjustment of preset temperature values at the fixing roller in various operational states in order to accelerate and improve the fixing process in automated environment.

In the presented invention, this task is solved by means of a method, according to Claim 1, in such a way that the generation and adjustment of preset temperature values at the outer surface of the fixing rollers is achieved essentially by means of a controllable and adjustable airflow of the cooling unit; and also the generation and adjustment of the airflow is effected on the basis of a determined core temperature of the fixing roller.

Furthermore, this method can be advantageously characterized by the fact that an initial preset temperature value of the fixing roller can be generated and adjusted by means of a heating unit brought to a constant maximum heating level, and after the initial preset temperature value has been reached, a first and a second operational level of the fixing unit can be reached through the airflow of the cooling unit driven by small to middle (0 to 50%) airflow levels; that a second preset lower temperature value of the fixing roller at constant maximum heating level can be generated and adjusted in a third operational state of the fixing unit achieved by means of an airflow through maximal (100%) to middle (50%) airflow levels; and that between the start of the second operational state “Request for a fixing task”, proceeding from the first operational state “Wait”, and a transition to the third operational state “Fixing” there is a time interval whose length depends on the operational mode of the fixing unit before the request for a fixing task, and particularly on the core temperature of the fixing roller and the type of the imaging material that carries the toner image.

According to the invention, this task is solved by means of a device as described in Claim 8 in such a way that the cooling unit has a blowing air unit essentially in the form of a pipe connected to a source of compressed air, which is mounted axially parallel to the fixing roller and is radially positioned in a fixed manner and at a distance from its outer surface, permitting to generate a cooling strip at the outer surface of the fixing roller by means of a focused and concentrated compressed airflow whose air level can be controlled and adjusted through a control/adjustment unit acting upon the source of compressed air.

In advantageous way, based on the supported direction of the imaging medium carrying the toner image, the blowing part of the cooling unit is mounted essentially in the direction of the airflow towards the fixing opening and at a distance from this opening in an area of the fixing roller; the blowing unit shows in its pipe wall at least one air nozzle in the form of a slot, which expands along its axial extent or a number of air nozzles, which are arranged along its axial extent, with the purpose of generation of concentrated and focused compressed airflow, which permits to create a cooling strip that extends itself over the whole axial length of the outer surface of the fixing roller; and the obtained width of the whole cooling strip, which is formed by the separate cooling strips of the compressed air blowing unit, is essentially equal or less than one-fourth of the outer surface of the fixing roller.

The further characteristics and advantages are available from the description of the examples of implementations of the invention, which are shown in the drawing, as well as from the further sub-claims. The drawing shows in:

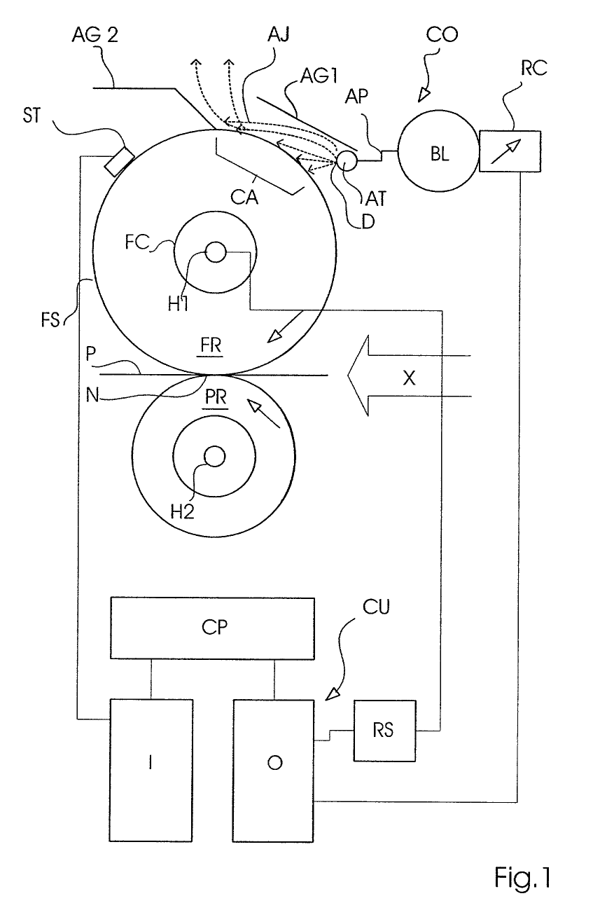

FIG. 1 schematic view of the device with a fixing unit, implemented according to the invention, seen in a lateral cross-section in axial direction to the fixing roller.

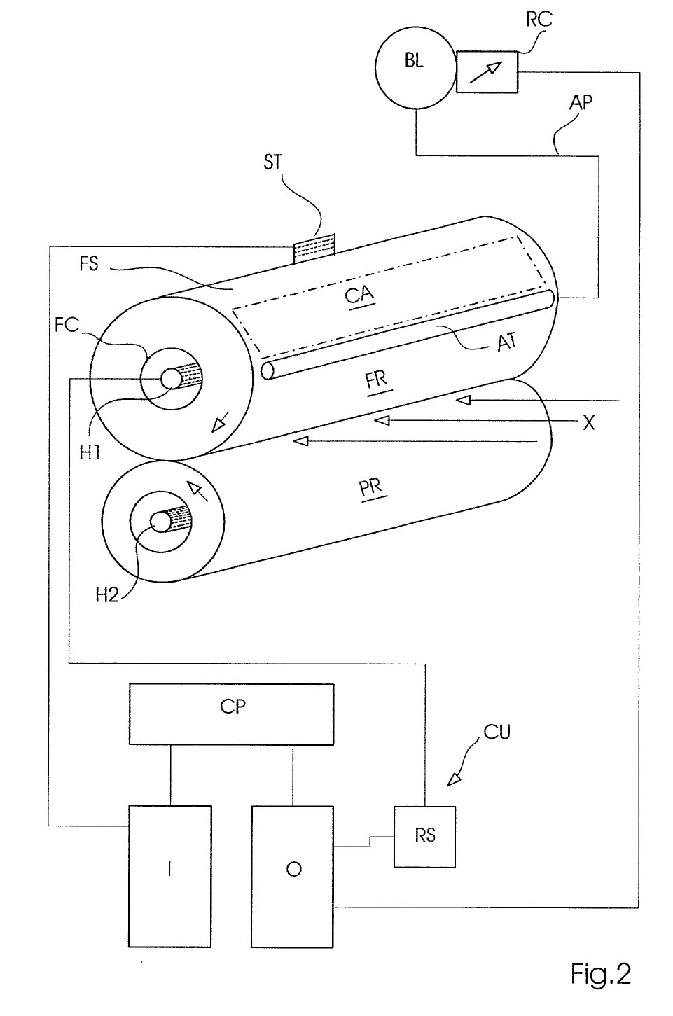

FIG. 2 the device from FIG. 1, implemented according to the invention, shown in 3-dimensional view.

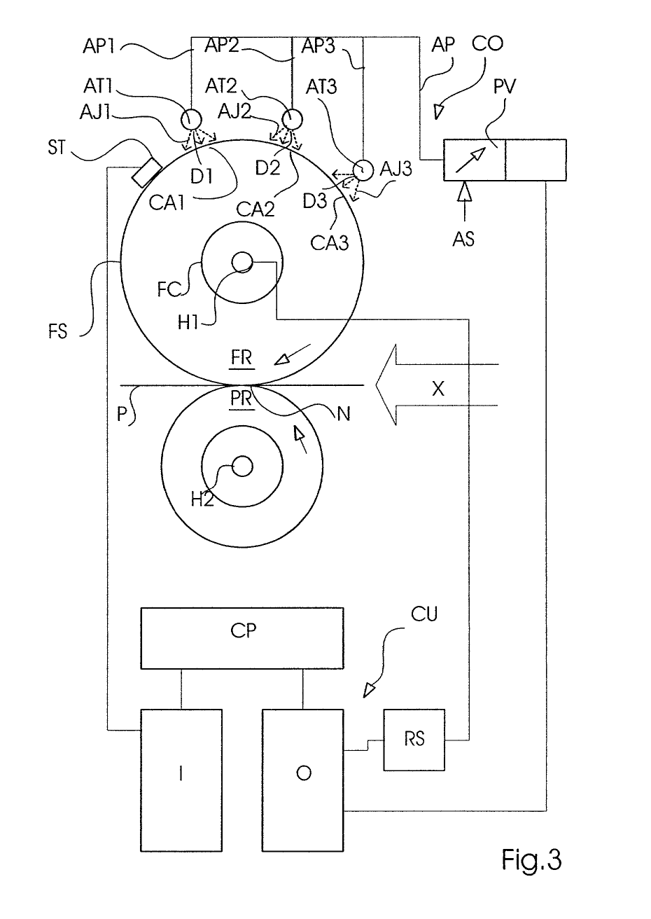

FIG. 3 the device from FIG. 1, implemented according to the invention, shown in an alternative form of implementation.

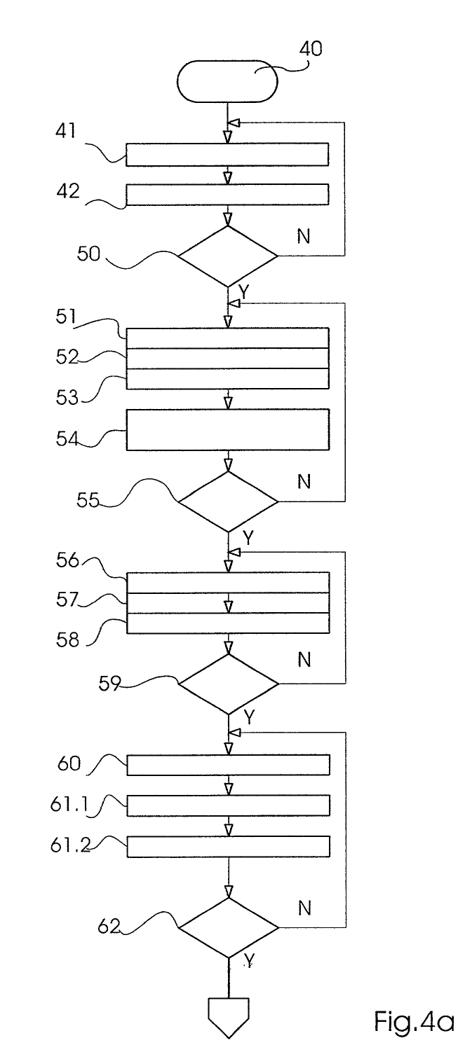

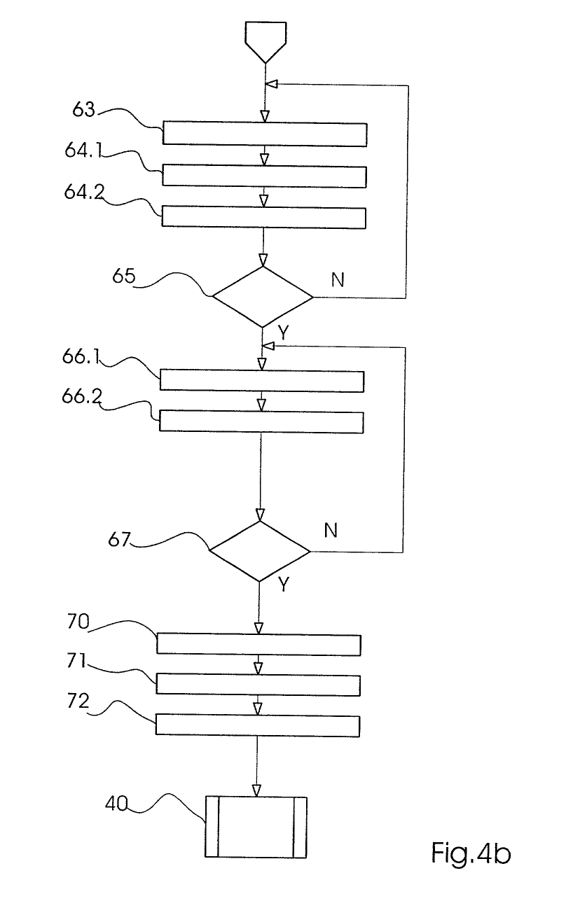

FIG. 4a and FIG. 4b the method, according to the invention, shown as functional diagram and flow/sequence diagram.

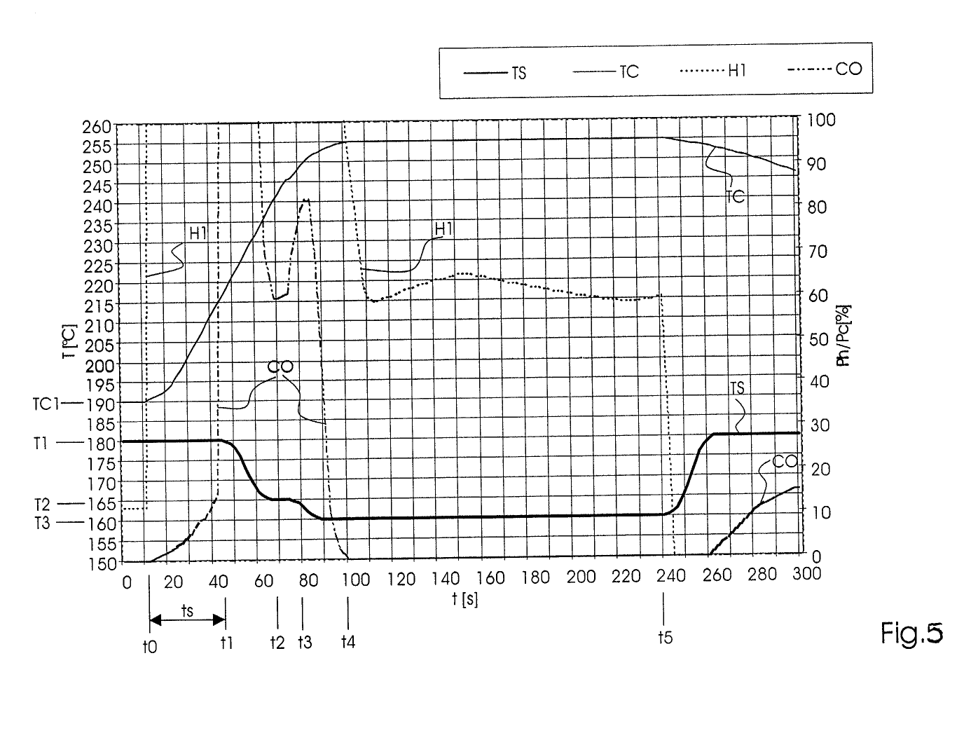

FIG. 5 the method from FIG. 4, according to the invention, shown as temperature/time diagram of the fixing roller and as heating level/time diagram of the heating unit and the compressed air unit.

The following description, according to FIG. 1 through FIG. 5, reflects a preferred form of implementation of a device based on the present invention and a method of generating and adjusting the temperature values of a rotating fixing roller of a fixing unit mounted in a copy machine and used for fixing of toner images transmitted by means of imaging medium.

The device is then mounted in the fixing unit of a duplicating machine of the known kind, e.g. copy machine.

For a specialist working in this specialized field, it is obvious that the device based on this invention can be used also in the fixing units of other machines, e.g. in printers.

The device for generation and adjustment of temperature values Ts, T1, T2, and T3, which is implemented according to the invention and is shown in schematic view in FIG. 1 and FIG. 2, is mounted on the fixing roller FR of a fixing unit that can be switched to different operational states W, A, and F and used for fixing of toner images carried by imaging material P, and then the unit is mounted into a traditional copy machine, which is not shown. The hollow fixing roller FR, which can be brought to rotation by an engine that is not shown, forms in the fixing unit along with a pressing roller PR that can be rotated and is mounted axially parallel to its outer surface FS-a fixing opening N used to lead through it in the shown direction of transportation X the imaging material carrying the toner image, whereby the imaging material carrying the toner image can be implemented for example in the form of paper sheets or foil sheets.

The fixing roller FR can be heated by means of a heating unit H1, for example a heating lamp, which is mounted centrally in the rotational axis of the hollow inner section of the roller and is electrically connected/coupled to a control/adjustment unit CU via the semiconductor relay RS of the output switching circuit O of a microprocessor unit CP. In this way, the heating unit H1 can be switched on to its heating level Ph and set up for generation and adjustment of the preset temperature values Ts, T1, T2, and T3 by means of the control/adjustment unit CU and the semiconductor relay RS.

The turning pressing roller PR, which is also mounted centrally in its hollow inner section, is heated by a heating unit H2 in the form of a heating lamp H2 whose heating level can be maintained at a predetermined constant value.

Besides, the outer surface FS of the fixing roller FR can be cooled out by means of an airflow fed by a cooling unit, which is controlled by the control/adjustment unit CU.

The cooling unit CO has an essentially pipe-formed airflow blowing unit AT connected to a compressed air source BL, which is stationary mounted axially parallel to the fixing roller FR and radially positioned at a distance from its outer surface FS and through which a focused and concentrated compressed airflow AJ for creating a cooling strip CA on the outer surface of the fixing roller can be generated and whose airflow level Pc can be controlled and adjusted by a control/adjustment unit CU, which controls the compressed air source BL. The generation of the focused and concentrated and respectively spatially limited airflow, respectively cooling strip, is supported by one first air conducting element AG1 in the form of a sheet, which is mounted on the air blowing unit, and a second air conducting element AG2 in the form of a sheet mounted above the fixing roller.

With respect to the feeding direction X of the imaging material carrying the toner image, respectively the paper sheet P, the blowing air unit AT of the cooling unit CO is mounted essentially in the direction of the airflow at the fixing opening N in an area of the fixing roller FR, which is at a distance from this fixing opening.

The temperature values Ts, T1, T2, and T3 can be registered at the outer surface FS of the fixing roller FR by means of a temperature sensor ST, which is electrically connected/coupled to the control/adjustment unit CU via an input switching circuit I. Furthermore, for the registration of the temperature values Ts, T1, T2, and T3 at the outer surface FS of the turning fixing roller FR, the temperature sensor ST is mounted in the opposite direction of the airflow between the blowing air unit AT and the fixing opening N and is in contact with the outer surface FS of the fixing roller FR.

In an alternative, not shown here form of implementation of the device, implemented according to the invention, there are several temperature sensors mounted, whereby the temperature sensor(s) ST is/are positioned radially at a distance from the outer surface and the temperature values of the fixing roller are registered in a contactless manner.

As it has been shown in FIG. 2, the blowing unit AT is implemented in the form of a cylindrical pipe with essentially a circular cross-section profile whose first axial end is hermetically closed and its other end is connected to the compressed air source BL. The blowing unit AT has in its pipe wall at least one air nozzle D in the form of a slot extended along its axial length, which is used for generation of a concentrated and focused blowing airflow AJ by means of which a cooling strip CA extended over the total axial length of the fixing roller and with a predetermined width can be created on the outer surface FS of the fixing roller FR.

The air nozzle D of the blowing unit AT has along the axial length of the fixing roller FR predetermined different diameters, forms, or different distances from each other (not shown) in such a way that an inhomogeneous warming of the fixing roller along its axial length can be prevented by means of a predetermined compensatory cooling, e.g. when the width of the sheet is less than the axial length of the fixing roller.

The width of the cooling strip CA formed by the airflow of the blowing unit of the cooling unit CO is essentially equal to or less than one-fourth of the outer circumference FS of the fixing roller FR.

As it is shown in FIG. 1 and FIG. 2, the compressed air source of the cooling unit CO is implemented as a motor-driven ventilator BL; the blowing unit AT is connected to the ventilator with an air channel AP; and the blowing airflow AJ of the blowing unit can be controlled and adjusted by changing the number of revolutions of the ventilator BL, which is done by means of the control/adjustment unit CU and another unit connected to its output circuit O and used for setting up the number of revolutions of the motor. Furthermore, the cooling unit CO has at its blowing unit AT a blowing airflow AJ with air over-pressure equal to or less than 1.5 bar and airflow level equal to or less than 16 liter/sec.

In an alternative form of implementation of the device, implemented according to the invention, as shown in FIG. 3, the cooling unit CO has three blowing units AT1, AT2, and AT3 arranged one behind the other in the direction of rotation of the fixing roller FR, which are mounted parallel to each other and in a concentric manner with respect to the fixing roller; and also, the three blowing units AT1, AT2, and AT3 are arranged in the direction of rotation at such an angular distance to each other that the cooling strips CA1, CA2, and CA3 generated by the blowing airflows AJ1, AJ2, and AJ3 on the outer surface FS of the fixing roller FR are either at a distance from each other or are in contact among each other.

Furthermore, the blowing units AT1, AT2, and AT3 have several air nozzles D1, D2, and D3 for generation of concentrated and focused blowing airflows (not shown) positioned along their axial length, by means of which on the outer surface FS of the fixing roller FR three cooling strips CA1,CA2, and CA3 with predetermined width can be generated, which extend over the whole axial length of the fixing roller. The resulting width of the whole cooling strip obtained from the three separate cooling strips CA1, CA2, and CA3 of the blowing units AT1, AT2, and AT3 is essentially equal or less than one-fourth of the outer surface FS of the fixing roller FR.

In this alternative implementation, the compressed air source of the cooling unit CO is built as a traditional for the industry compressed-air compressor AS, which is not shown.

The blowing air units AT1, AT2, and AT3 are connected via a controllable air valve PV to the compressed-air compressor AS and can be controlled separately or all of them by the control/adjustment unit CU for control and adjustment of the blowing airflows AJ1, AJ2, and AJ3 of the blowing units AT1, AT2, and AT3.

The mode of action of the device is as follows and can be characterized through the following steps, respectively reference numbers on the flowchart according to FIG. 4a and FIG. 4b as well as on the temperature/performance time chart in FIG. 5:

The mode of action of the device in further details:

Proceeding from an initial stable operational state “Wait” W of the fixing unit (corresponding to the above mentioned mode of action and the flowchart in FIG. 4a, Step 40, as well as in FIG. 5), in which the pressing roller PR along with the oil/cleaning roller has departed or has risen off the rotating fixing roller FR and the temperature Ts on the outer surface FS of the fixing roller FR shows its first temperature value T1, which is adjusted to T1=180-181° C. with the heating unit H1 of the fixing roller FR working with 10-15% of its heating capacity (Step 41) and through the blowing airflow AJ, AJ1-3 of the cooling unit CO (reference number 42), the first switching to operational state A is undertaken (reference number 50) and with that the “Request and preparation for a new/first fixing task” operational state is started by a serviceperson, respectively by a control program of the copy machine at time point to=11 s, as shown in FIG. 5.

After the start, respectively after the switching over (Step 50) from the first operational state W to the second operational state A of the fixing unit, the first predetermined temperature value T1 of the fixing roller FR is generated and adjusted with the heating unit H1 being maintained at a constant maximal heating level Ph (Step 51), and after reaching the predetermined first temperature value T1, this temperature value H1 is regenerated and readjusted by means of a blowing airflow AJ of the cooling unit CO driven by small through middle (0 to 50%) airflow level Pc (Step 53).

Then, after a time interval/time span ts of the time-clock unit (FIG. 4a, Steps 56, 58-61.2, and FIG. 5), a second predetermined and lower temperature value T2=165° C. of the fixing roller FR is generated and adjusted for and in the third operational state (F) of the fixing roller at further constant maximal heating level Ph by means of a maximal (100%) to middle (around 50%) airflow level Pc driven blowing airflow AJ, AJ1-3.

The time between the start of the second operational state A “Request/preparation for a fixing task” and the switching over to the third operational state F “Fixing”-around at the time point t2=70 s (FIG. 5), is determined essentially by the time interval/time span ts=t1-t2 (FIG. 5) generated by the time-clock unit and its duration depends on the operational mode of the fixing unit before the request of the fixing task, and particularly on the core temperature T1 of the fixing roller FR before the request of the fixing task, as well as on the first operational state W “Wait” and the type of the imaging material P carrying the toner image.

After the second predetermined temperature value T2 in the third operational state F “Fixing” (Step 62) has been reached, a third predetermined temperature value T3=160-161° C. of the fixing roller FR is generated by placing/moving the pressing roller PR onto the fixing roller FR (Step 63) around the time point t3=80s (FIG. 5); and this third temperature value is adjusted to the second lower temperature value T3 (FIG. 4b , Steps 65-66.2) by means of adjusted heating level Ph of the heating unit H1 and through adjusted air level Pc of the blowing airflow AJ, AJ1-3 since reaching essentially 100% of the core temperature Tc of the fixing roller FR around the time point t4=100 s (FIG. 5) and actually till the end of the fixing task around the time point t5.

The generation and adjustment of the predetermined temperature values T1, T2, and T3 on the outer surface FS of the fixing roller FR is completed essentially by means of the controllable and adjustable blowing airflow AJ, AJ1-3 of the cooling unit, whereby the control and the adjustment of the blowing airflow AJ, AJ1-3 is performed also depending on the obtained core temperature Tc of the fixing roller FR.

The placing/moving of the pressing roller PR (FIG. 4b , Step 63) takes place here along with that of an oil/cleaning roller towards a time point t3 (FIG. 5), which depends on the obtained time interval/time span ts for switching over to operational state F “Fixing”, whereby the core temperature Tc of the fixing roller FR amounts to about 90% and the forward end of the first imaging material P in the form of a sheet carrying the toner image is fed into the fixing opening N; whereby the start of the introduction of the imaging material P in the form of a sheet carrying the toner image through the fixing opening P depends on, or is determined by the obtained time interval/time span.

During the operational states A and F, “Request of a fixing task” and “Fixing”, the core temperature Tc of the fixing roller FR is essentially determined by and is obtained from the switching time interval t and the heating level Ph of the heating unit H1 using specific values of the fixing roller as thermal capacity and thermal conductivity as well as from the core temperature Tc1 (FIG. 5) of the fixing roller FR before the request of fixing task.

Both gradients (adjustment values according to Steps 52 and 57 (FIG. 4)) are built depending on the obtained core temperatures Tc (FIG. 5) of the fixing roller in such a way that the adjustment of the blowing airflow AJ, AJ1-3 becomes possible depending on the temperature deviations on the outer surface FS of the fixing roller FR after taking into account the obtained core temperature Tc.

List of Drawings

A Operational state “Request/preparation for a fixing task”

F Operational state “Fixing”

W Operational state “Wait”

AG1 First air conducting element at the blowing air unit (cooling unit)

AG2 Second air conducting element at the fixing roller (cooling unit)

AJ Blowing airflow of the blowing air unit (cooling unit)

AJ1 Blowing airflow of the first blowing air unit (alternative cooling unit)

AJ2 Blowing airflow of the second blowing air unit (alternative cooling unit)

AJ3 Blowing airflow of the third blowing air unit (alternative cooling unit)

AP Air channel between the blowing air unit and the source of compressed air (cooling unit)

AP1 Air channel between the first blowing air unit and the source of compressed air (alternative cooling unit)

AP2 Air channel between the second blowing air unit and the source of compressed air (alternative cooling unit)

AP3 Air channel between the third blowing air unit and the source of compressed air (alternative cooling unit)

AT Blowing air unit (air pipe) of the alternative cooling unit

AT1 First blowing air unit (air pipe) of the cooling unit

AT2 Second blowing air unit (air pipe) of the alternative cooling unit

AT3 Third blowing air unit (air pipe) of the alternative cooling unit

AS Compressed air compressor (compressed air source of the alternative cooling unit)

BL Ventilator (compressed air source of the cooling unit)

CA Cooling strip on the outer surface of the fixing roller

CA1 First cooling strip on the outer surface of the fixing roller (alternative cooling unit)

CA2 Second cooling strip on the outer surface of the fixing roller (alternative cooling unit)

CA3 Third cooling strip on the outer surface of the fixing roller (alternative cooling unit)

CO Cooling unit

CP Microprocessor unit

CP/I Input switching circuit of the Microprocessor unit

CP/O Output switching circuit of the Microprocessor unit

CU Control/Adjustment

D Air nozzle at the blowing air unit (cooling unit)

D1 First air nozzle at the blowing air unit (alternative cooling unit)

D2 Second air nozzle at the blowing air unit (alternative cooling unit)

D3 Third air nozzle at the blowing air unit (alternative cooling unit)

H1 Heating unit of the fixing roller

H2 Heating unit of the pressing roller

FR Fixing roller

FC Core/internal circumference surface of the fixing roller

FS Outer surface of the fixing roller

N Fixing opening of the fixing agent/fixing roller of the fixing unit

P Imaging medium/sheet (paper, foil, etc.) carrying the toner image

PR Pressing roller

PV Controllable air valve at the blowing air unit (alternative cooling unit)

Pc Cooling level of the blowing airflow (cooling unit)

Ph Heating level of the heating unit of the fixing roller

RS Semiconductor relay for the heating unit

RC Device for setting up the number of revolutions of the motor of the ventilator of the cooling unit

ST Temperature sensor on the outer surface of the fixing roller

T1 First temperature value (180° C.) on the outer surface of the fixing roller in operational state “Wait”

T2 Second temperature value (165° C.) on the outer surface of the fixing roller in operational state “Request/preparation for a fixing task”

T3 Third temperature value (160° C.) on the outer surface of the fixing roller in operational state “Fixing”

Ts Temperature on the outer surface of the fixing roller

Tc Temperature on the core/internal circumference surface of the fixing roller

ts Time interval/time span of the time-clock unit (depending on the type of the imaging material/paper and the core-temperature of the fixing roller before operational state A)

to Starting time point of operational state A

t1 Time point after the time interval/time span and for gradient building

t2 Time point at which the preparation of the fixing task has been completed and the second

temperature value T2=165° C. has been reached, and the transport of the imaging material/paper has begun

t3 Time point at which the forward edge of the first sheet has reached the fixing opening and at which the pressing roller with the oil/cleaning roller has been placed over the fixing roller

t4 Time point at which the core temperature of the fixing roller has reached 100% and at which the adjustment of the heating level and the adjustment of the air level have got active together

t5 Time point at which the last sheet of the fixing task leaves the fixing opening and at which the pressing roller moves away from the fixing roller

X Supported direction of the imaging material carrying the toner image

40. Fixing roller/fixing unit are in operational state “W”

41. Fixing roller/outer surface is adjusted to T1=180° C. by means of the heating unit

42. Fixing roller/outer surface is adjusted to T1=181° C. by means of the cooling unit

50. A new fixing task has been requested & task preparation/operational state “A”

51. The heating unit of the fixing roller has been switched to constant 100%

52. Build the first gradient for adjustment of the blowing airflow as function of the core temperature

53. Adjust the fixing roller with the cooling unit to T1=180° C.

54. Start the time-clock unit; build the time interval/time span depending on the paper type and the core temperature

55. The time point at the end of the time interval/time span has been reached

56. The heating unit of the fixing roller has been switched to constant 100%

57. Build the second gradient for adjustment of the blowing airflow as function of the core temperature

58. Adjust the fixing roller with the cooling unit to T2=165° C.

59. The temperature value of the fixing roller has reached T2=165° C.

60. Start of the sheet transport of fixing task/operational state “F”

61.1 The heating unit of the fixing roller has been switched to constant 100%

61.2 Adjust the fixing roller with the cooling unit to T2=165° C.

62. First sheet with its forward edge in the fixing opening? (Core temperature around 90%)

63. Place/move the pressing roller along with the oil/cleaning roller on the fixing roller

64.1 The heating unit of the fixing roller has been switched to constant 100%

64.2 Adjust the fixing roller with the cooling unit to T=160° C.

65. 100% core temperature at the fixing roller reached?

66.1 Adjust the fixing roller with the heating unit to T3=160° C.

66.2 Adjust the fixing roller with the cooling unit to T3=161° C.

67. Fixing task ended?

70. Adjust the fixing roller with the heating unit to T3=180° C.

71. Adjust the fixing roller with the cooling unit to T3=181° C.

72. Take off/move out the pressing roller with the oil/cleaning roller from the fixing roller

1. A method for generation and adjustment of temperature values (T1, T2, and T3) at a fixing roller (FR) of a fixing unit, which is mounted in a copy machine and can be switched over to different operational states (W, A, F) for fixing imaging material (P) carrying toner images, whereby the fixing roller, which can rotate, along with a pressure roller (PR), which is parallel to the axis and can be placed on its outer surface (FS), build a fixing opening (N) for feeding through imaging material carrying toner images; the fixing roller can be heated by means of a heating unit (H1) connected to a control/adjustment unit (CU), which can be switched for generation and adjustment of predetermined temperature values (T1, T2, and T3) and its heating level (Ph) can be adjusted; the temperature values (T1, T2, and T3) on the outer surface (FS) of the fixing roller can be obtained by means of at least one temperature sensor (ST); and the outer surface of the fixing roller can be cooled out by means of a blowing airflow (AJ, AJ1-3) fed by a controllable cooling unit (CO);
with the characteristics
that the generation and adjustment of the predetermined temperature values (T1, T2, and T3) on the outer surface (FS) of the fixing roller (FR) are performed essentially by means of a controllable and adjustable blowing airflow (AJ, AJ1-3) of the cooling unit (CO); and the control and adjustment of the blowing airflow (AJ, AJ1-3) is performed depending on a determined core temperature (Tc) of the fixing roller (FR).

2. Method according to claim 1
with the characteristics
that a first predetermined temperature value (T1) of the fixing roller (FR) is generated and adjusted by means of a heating unit (H1) run at constant maximal heating level (Ph), and after reaching the first temperature value of the blowing airflow (AJ, AJ1-3) of the cooling unit (CO) driven by small to middle (0 to 50%) airflow level (Pc), it switches over from a first (W) to a second (A) operational state of the fixing unit; and a predetermined lower temperature value (T2) of the fixing roller (FR) at further constant heating level (Ph) is generated and adjusted into a third operational state (F) of the fixing unit by means of a blowing airflow (AJ, AJ1-3), which is run at maximal (100%) to middle (about 50%) airflow level (Pc).

3. Method according to claim 2
with the characteristics
that the time between the start of the second operational state (A) “Request/preparation for a fixing task” and the switching over to a third operational state (F) “Fixing” is essentially determined from a time interval/time span (ts) obtained by means of a time-clock unit and whose length depends on the operational state of the fixing unit before the request for a fixing task, and particularly on the core temperature (Tc1) of the fixing roller (FR) before the request for a fixing task, on the first operational state (W) “Wait”, and on the type of the imaging material (P) carrying toner images.

4. Method according to claim 3
with the characteristics
that a third predetermined temperature value (T3) of the fixing roller (FR) is generated by placing/moving out the pressing roller (PR) at the fixing roller (FR) after reaching the second predetermined temperature value (T2) in the third operational state (F) “Fixing”; and this third, second lower temperature value (T3), is then adjusted by means of adjusted heating level (Ph) of the heating unit (H1) and through the adjusted air level (Pc) of the blowing airflow (AJ, AJ1-3) from the moment of reaching essentially 100% of the core temperature (Tc) of the fixing roller (FR).

5. Method according to claim 4
with the characteristics
that the placing/moving out the pressing roller (PR) together with the oil/cleaning roller occurs at a point in time that depends on the obtained time interval/time span (ts) for switching over to operational state (F) “Fixing”, at which the core temperature (Tc) of the fixing roller (FR) lies around 90% and the forward end of the first imaging material (P) in the form of a sheet carrying toner images is fed into the fixing opening (N); and the start of introducing the imaging material (P) in the form of a sheet carrying toner images into the fixing opening (N) depends on the obtained time interval/time span (ts).

6. Method according to claim 1 or claim 5
with the characteristics
that during the operational states (A and F) “Request for a fixing task” and “Fixing”, the core temperature (Tc) of the fixing roller (FR) is determined and obtained essentially from the switching time (t) and the heating level (Ph) of the heating unit (H1), from the specific values of the fixing roller, e.g. heat capacity and heat conductivity, as well as from the core temperature (Tc1) of the fixing roller (FR) before the request for a fixing task (A); also, a gradient (a quantity based on a rule) is built depending on the obtained core temperature (Tc) of the fixing roller (FR), which allows to adjust the blowing airflow (AJ, AJ1-3) depending on the temperature deviation at the outer surface (FS) of the fixing roller (FR) while taking into account the obtained core temperature (Tc).

7. Method according to claim 2 or claim 4
with the characteristics
that the first predetermined temperature value (T1) is set to 180° C., the second predetermined temperature value (T2) is set to 165° C., and the third predetermined temperature value (T3) is set to 160° C.

8. A device for generation and adjustment of temperature values (T1, T2, and T3) at a fixing roller (FR) of a fixing unit, which is mounted in a copy machine and can be switched over to different operational states (W, A, F) for fixing imaging material (P) carrying toner images, whereby the fixing roller, which can rotate, along with a pressure roller (PR), which is parallel to the axis and can be placed on its outer surface (FS), build a fixing opening (N) for feeding through imaging material carrying toner images; the fixing roller can be heated by means of a heating unit (H1) connected to a control/adjustment unit (CU), which can be switched for generation and adjustment of predetermined temperature values (T1, T2, and T3) and its heating level (Ph) can be adjusted; the temperature values (T1, T2, and T3) on the outer surface (FS) of the fixing roller can be obtained by means of at least one temperature sensor (ST); and the outer surface of the fixing roller can be cooled out by means of a blowing airflow (AJ, AJ1-3) fed by a controllable cooling unit (CO);
with the characteristics
that the cooling unit (CO) has at least one blowing air unit (AT, AT1-3) essentially in the form of a pipe and connected to a compressed air source (BL, AS), whereby the blowing air unit (BL, AS) is mounted in a stationary manner and axially parallel to the fixing roller (FR) and radially at a distance from its outer surface (FS), and through it a focused and concentrated blowing airflow (AJ, AJ1-3) can be obtained in order to create a cooling strip (A, A1-3) on the outer surface of the fixing roller, whereby its airflow level (Pc) can be controlled and adjusted by means of a control/adjustment unit (CU) acting upon the compressed air source (BL, AS).

9. Device according to claim 8
with the characteristics
that the blowing air unit (AT, AT1-3) of the cooling unit (CO)-in relation to the supported direction (X) of the imaging medium (P) carrying the toner image-is mounted essentially in the direction of the airflow towards the fixing opening (FR), which is at a distance from this fixing opening.

10. Device according to claim 8 or claim 9
with the characteristics
that the cooling unit (CO) has three blowing air units (AT1, AT2, and AT3) arranged one behind the other in the direction of rotation of the fixing roller (FR), which are positioned parallel to each other and in a concentric layout in relation to the fixing roller; and the three blowing air units (AT1, AT2, and AT3) are mounted in the direction of rotation and at such an angular distance from each other that the cooling strips (CA1, CA2, and CA3) formed through their blowing airflows (AJ1, AJ2, and AJ3) at the outer surface (FS) of the fixing roller (FR) are either at a distance from each other, or are touching one another.

11. Device according to claim 8 or claim 10
with the characteristics
that the blowing air unit (AT, AT1-3) is built in the form of a cylindrical pipe with essentially circular cross-section profile whose first axial end is hermetically closed and its second end is connected with the compressed air source (BL, AS)>

12. Device according to claim 8 or claim 10
with the characteristics
that the blowing air unit (AT, AT1-3) has in its pipe wall at least one air nozzle (D, D1-3) in the form of a slot, which extends itself along its axial length and is used for generation of concentrated and focused blowing airflow (AJ, AJ1-3), by means of which a cooling strip (CA, CA1-3) with predetermined width and extending itself along the whole axial length of the fixing roller can be generated at the outer surface (FS) of the fixing roller (FR).

13. Device according to claim 8 or claim 10
with the characteristics
that the blowing air unit (AT, AT1-3) has in its pipe wall a number of air nozzles (D, D1-3) arranged along its axial length for generation of concentrated and focused blowing airflow, by means of which a cooling strip (CA, CA1-3) with predetermined width and extending itself along the whole axial length of the fixing roller can be generated at the outer surface (FS) of the fixing roller (FR).

14. Device according to claim 12 or claim 13
with the characteristics
that the air nozzles (D,D1-3) of the blowing air unit (AT, AT1-3) along the axial length of the fixing roller (FR) have different predetermined diameters, forms, or different distances from one another in such a way that an inhomogeneous warming of the fixing roller along its axial length can be prevented by means of predetermined balancing cooling.

15. Device according to claim 10
with the characteristics
that the width of the whole cooling strip generated from the separate cooling strips (CA, CA1-3) of the blowing air unit (AT, AT1-3) is essentially equal or less than one-fourth of the outer surface of the of the fixing roller (FR).

16. Device according to claim 8 or claim 11
with the characteristics
that the compressed air source of the cooling unit (CO) is built as a motor-driven ventilator (BL); the blowing air units (AT, AT1-3) are connected with the ventilator (BL) by means of the air channels (AP, AP1-3); and the air valves (PV) can be controlled individually or all together by means of the control/adjustment unit (CU) in order to control and adjust the blowing airflow (AJ, AJ1-3) of the blowing air unit.

17. Device according to claim 8 or claim 11
with the characteristics
that the compressed air source of the cooling unit (CO) is built as a motor-driven ventilator; the blowing units (AT, AT1-3) are connected by means of the air channels (AP, AP1-3) with the ventilator (BL): and the blowing airflow (AJ, AJ1-3) of the blowing air unit can be controlled and regulated through changes in the number of revolutions of the ventilator (BL), which can be effected by means of the control/adjustment unit (CU) and the unit for setting the number of revolutions of the motor (RC).

18. Device according to claim 8 or claim 16 or claim 17
with the characteristics
that the cooling unit (CU) has at its blowing air unit (AT, AT1-3) a blowing airflow (AJ,AJ1-3) with air over-pressure equal or less than 1.5 bar and with air level (Pc) equal or less than 16 liter/sec.

19. Device according to claim 8
with the characteristics
that at least one temperature sensor (ST) for measurement of the temperature values (TS, T1, T2, and T3) on the outer surface (FS) of the rotating fixing roller (FR) is mounted in the direction of the airflow (downstream) in relation to the supported direction (X) of the imaging material (P) carrying toner images between the blowing air unit(s) (AT, AT1-3) and the fixing opening (N); and the temperature sensor (ST) stays in contact with the outer surface (FS) of the fixing roller (FR) or measures the temperature values (TS, T1-3) without entering in contact with and staying at a distance from the outer surface.
